(19) United States
(12) Patent Application Publication
(10) Pub. No.: US 2012/0231147 A1
(43) Pub. Date: Sep. 13, 2012

(54) Xylo-oligosaccharides production by autohydrolysis of grain products

(76) Inventors: Radhakrishnan Srinivasan, Starkville, MS (US); Aditya Samala, Starkville, MS (US)

(21) Appl. No.: 13/385,745

(22) Filed: Mar. 5, 2012

Related U.S. Application Data
(60) Provisional application No. 61/464,416, filed on Mar. 4, 2011.

(51) Int. Cl. A23L 1/308; A23L 1/20; A23L 1/10

(52) U.S. Cl. 426/618; 426/615; 426/634

(57) ABSTRACT

The present invention provides a novel method for producing functional food ingredients such as XOS by autohydrolysis of grain products, including corn fiber separated from DDGS, thereby creating products having prebiotic and antioxidant benefits.

### CROSS-REFERENCE TO RELATED APPLICATION

This application claims priority from U.S. Provisional Patent Application Ser. No. 61/464,416 filed Mar. 4, 2011. The entirety of that provisional application is incorporated herein by reference.

### STATEMENT OF GOVERNMENT SUPPORT

This invention was made with government support under grant DE-FG36-06GO86025 awarded by the U.S. Department of Energy. The government may have certain rights in the invention.

### FIELD OF THE INVENTION

This invention relates to the field of producing functional food ingredients and more specifically to the field of producing oligosaccharides, and specifically xylo-oligosaccharides (XOS), from grain products, specifically corn fiber, and corn fiber separated from distillers dried grains with solubles (DDGS).

### BACKGROUND OF THE INVENTION

The present invention provides for a novel method of producing food ingredients such as xylo-oligosaccharides from different grain products such as corn fiber and from corn fiber separated from DDGS.

The present invention in a preferred embodiment utilizes autohydrolysis to produce XOS and other functional food ingredients from grain products and optimizes temperature for the production of XOS.

Xylo-oligosaccharides (XOS) are reported to have beneficial health properties and are considered to be functional food ingredients. XOS was produced using corn fiber separated from distillers dried grains with solubles (DDGS). Corn fiber was treated with deionized water in a Parr-reactor, at temperatures ranging from about 140° C. to about 220° C. to produce XOS by autohydrolysis and to determine the optimum temperature for XOS production. The reaction was conducted with 10 grams of corn fiber in 90 mL of deionized water. The holding time after desired temperature reached was about 15 min. The maximum total yield of XOS in the solution was about 17.9 to about 18.6 wt % of the corn fiber at about 170-180° C. There were no traces of formic acid and levulinic acid. The present invention shows that XOS can be produced from corn fiber, which may provide health benefits, including prebiotic and antioxidant activities.

U.S. Pat. No. 7,670,633 and Application Publ. No. US2010/0206780 involve a process called the Elusieve process of fiber separation from grain products such as corn flour, soybean meal, cottonseed meal, wheat middlings, and DDGS. This Elusieve process technology separates components such as fiber from the grain products and byproducts into useable fiber-enriched and fiber-reduced products. The present invention utilizes materials, i.e., grain products, that have had fiber separated or removed by any process, including the Elusieve process, to produce functional food ingredients such as XOS.

A need exists in the field of functional food ingredient production for a novel method of producing XOS and similar ingredients and at the optimum temperature range. The present invention provides such a method.

### SUMMARY OF THE INVENTION

The present invention provides for a novel method of producing functional food ingredients, specifically XOS, from grain products and specifically from corn fiber and corn fiber separated from DDGS. The invention provides for a method of using autohydrolysis of fiber separated from DDGS and utilizing the optimum temperature(s) for XOS and similar functional food ingredient production.

With the foregoing and other objects, features, and advantages of the present invention that will become apparent hereinafter, the nature of the invention may be more clearly understood by reference to the following detailed description of the preferred embodiments of the invention and to the appended claims.

### BRIEF DESCRIPTION OF THE DRAWINGS

This drawing accompanies the detailed description of the invention and is intended to illustrate further the invention and its advantages:

FIG. 1 is a representative schematic illustration of the autohydrolysis of corn fiber to produce XOS and its acid hydrolysis to monomers.

### DETAILED DESCRIPTION OF THE INVENTION

### 1. Introduction

The need for renewable energy sources has led to a rapid increase in the production of fuel ethanol and its co-product, distillers dried grains with solubles (DDGS). DDGS consists of non-fermentable components of the original grain, such as protein, lipids, and fiber. DDGS has become important in maintaining the economic viability of the renewable bio-fuel industry. For every 1 kg of corn utilized, nearly ⅓ kg of each of the products, ethanol, DDGS, and CO₂, are produced. In 2006, nearly 10 million metric tons of DDGS were produced from this industry. DDGS, which has high protein and fiber contents, is used as livestock feed, mainly as ruminant (cattle) feed. However, with an increase in supply of distillers grains, innovative uses for DDGS are needed to increase its value. The present invention comprises a novel method of utilizing fiber separated from DDGS for the production of xylo-oligosaccharides (XOS), which can be used as valuable functional food ingredients.

Recently, fiber has been separated from DDGS using a combination of sieving and air classification (the Elusieve process) to produce two beneficial co-products: (1) enhanced DDGS with reduced fiber, increased fat, and protein contents; and (2) fiber (Srinivasan, et al., 2006).

Enhanced DDGS from the Elusieve process has lower fiber content and hence has potential to be used at higher inclusion levels in non-ruminant animal diets. Currently, fiber separated from DDGS is believed to have limited use as feed for ruminant animals (dairy and beef cattle). The present invention provides for a novel method of production of xylo-oligosaccharides using fiber separated from grain products and from DDGS.

Monosaccharide molecules with a degree of polymerization (DP) between 2 and 10 are defined as oligosaccharides (Nakakuki, 1993). Oligosaccharides are considered as functional food ingredients with potential to reduce the risk and possibility of heart diseases, bacterial/viral infections, cancer, diabetes, hepatitis, emphysema, and cranial and muscular neurological diseases (Hakomori and Kannagi, 1983; Faissner et al., 1994; Gibson, 2001; Rivas, et al., 2002; Chu and Whittaker, 2004; Kawakubo, et al., 2004; Ohtsubo and Marth, 2006). Due to the various health benefits, oligosaccharides are used in the pharmaceutical and food industries. Commonly-used oligosaccharides are fructo-oligosaccharides, malto-oligosaccharides, galacto-oligosaccharides, and XOS. Oligosaccharides are used as antioxidant compounds in pharmaceutical industries and precursors for antiviral or antimural drugs, in preparation of micro and nanoparticles and hydrogels for drug delivery, and for treatment of gastrointestinal problems (Garcia, et al., 2001; Lindblad, et al., 2001).

XOS are defined as xylose-based oligomers linked by β-1, 4-bonds and contain variable amounts of substituted groups like acetyl, phenolic, and uronic acid. XOS are low-digestible sugars and utilized by most Bifidobacterium species. XOS are non-carcinogenic and considered as prebiotics because they stimulate growth and activity of beneficial bifidobacteria in the colon and are considered as functional foods due to their prebiotic nature. Prebiotics are defined as non-digestible food ingredients that benefit the host by stimulating the growth and activity of limited numbers of bacteria in the colon (Gibson and Roberfroid, 1995). Prebiotics have applications in pet foods, human foods, and animal feeds.

Different methods used for the production of xylo-oligosaccharides include: enzymatic hydrolysis, alkali/acid hydrolysis, and autohydrolysis of carbohydrate polymers. In enzymatic hydrolysis, enzymes such as endoxylanases, β-xylosidases, and arabinofuranosidases are used to break the xylan linkages to produce XOS. Enzymatic hydrolysis typically takes a longer time for completion than other methods. In the acid/alkali hydrolysis method, a dilute solution of acid or base is used to treat the substrates, typically at ambient temperature to produce XOS. In the autohydrolysis method, water is added to the substrate and the mixture is heated to 100° C. to 200° C. in an enclosed vessel to produce XOS. Autohydrolysis has advantages over the other methods that include short duration, lack of chemical usage, and simplicity. The objective of our study that led to the present invention was to carry out autohydrolysis of fiber separated from DDGS at different temperatures and to determine the optimum temperature(s) for production of XOS.

### 2. Materials and Methods

2.1. Fiber Separation from DDGS

DDGS was procured from a local feed mill and processed to separate fiber using the Elusieve pilot-plant at Mississippi State University (Srinivasan et al., 2009). The fiber used in this study was the large size fiber fraction. The fiber material was stored in vacuum sealed bags in a refrigerator at about 5° C. until used. The present invention provides for functional food ingredients, and specifically XOS, to be produced using materials or grain products that have had fiber separated or removed by any process, including the Elusieve process. The Elusieve fractionation process combines sieving and air classification or flow (elutriation) to separate fiber from the grain product and to accomplish fractionation of the material into component-enriched streams (i.e., protein, lipid, fiber) and component-reduced streams. (Srinivasan, et al. (2005-2010); U.S. Pat. No. 7,670,633; U.S. Patent Application Publ. No. US2010/0206780). The grain or grain product (ground corn flour, ground barley flour, ground wheat flour, ground sorghum flour, soybean meal, distillers dried grains with solubles (DDGS), and the like) is sieved into different sizes and air is blown through selected sizes to carry away component fiber. The grain product or corn fiber can be fiber or hulls, or a combination thereof, separated from ground corn flour, ground barley flour, ground wheat flour, ground sorghum flour, soybean meal, DDGS, or a combination thereof. As a result, the fiber separation also increases the starch content of ground corn flour and increases the protein content of soybean meal and DDGS.

### 2.2. Determination of Corn Fiber Composition

Three replicates of the corn fiber material were sent to the Integrated Paper Services, Inc., Appleton, Wis. for determination of corn fiber composition. The samples were milled to approximately 40-mesh. Prior to carbohydrate and lignin analysis, samples were extracted with dichloromethane (DCM) in a soxhlet apparatus to remove substances such as waxes, fats, resins, phytosterols, and non-volatile hydrocarbons. The percent of extractives of each sample was calculated based on its oven-dried weight. The carbohydrate and lignin content determination of three dichloromethane extracted samples was done in duplicate. Lignin content was determined according to TAPPI Test Method 60(10): 143/1977. Approximately 300 mg of sample t was hydrolyzed with acid and filtered. The acid-insoluble residue was oven-dried and weighted to calculate the percent of lignin content. The acid-soluble portion of each sample was neutralized, reduced, acetylated and their carbohydrate composition was determined according to TAPPI Test Method T249 Cm-00 using a Flame Ionization Detector-Gas Chromatograph (FID-GC).

### 2.3. Auto-Hydrolysis of Fiber

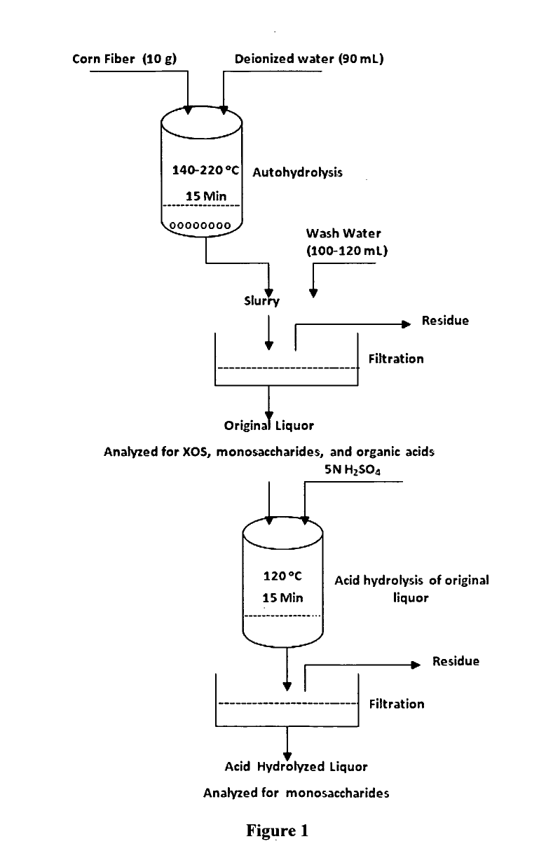

The autohydrolysis of fiber was conducted in a 750 mL Parr reactor (Model 4843, Parr Instruments Co., Moline, Ill., USA) (FIG. 1). The reactor (fitted with a six bolt metal cover) was heated with temperature control. In each batch, the Parr reactor was filled and loaded with 10 grams of corn fiber and 90 mL of deionized water. The treatment of fiber separated from DDGS samples was carried out at desired sets of temperatures, in intervals of 10° C., between about 140° C. and 220° C. Autohydrolysis was carried out in three replicates at each temperature, except for 200° C. and 220° C. The holding time after the optimum desired temperature reached was about 15 min. The holding time of about 15 min was chosen to ensure that the process attained steady-state. The reaction mixture was filtered by gravity filtration using a filter paper (Fisherbrand, USA), size P5 on a funnel. The filtrate was further filtered by a vacuum filtration system using a glass fiber prefilter (Millipore, USA) on a Buchner funnel. The reaction mixture was filtered twice to obtain particles free solution for HPLC analysis. The solid product was thoroughly washed with deionized water ranging from 100 mL to 120 mL depending upon oligosaccharides removal from residue and dried at room temperature. The washing was collected in a bottle, labeled as original liquor, and stored in the refrigerator at 0° C.

2.4. Acid Hydrolysis of Liquor from Autohydrolysis

The original liquor (100 mL) obtained after the autohydrolysis reaction of fiber was mixed with 20 mL of 5NH₂SO₄ and heated at 120° C. for 45 minutes to hydrolyze XOS to their monomeric sugars (FIG. 1) using NREL (National Renewable Energy Laboratory) procedure NREL/TP-510-42623. The acid hydrolyzed solution was filtered by a vacuum filtration on a Buchner funnel to remove insoluble materials.

### 2.5. Quantification of XOS, Monosaccharides, and Acids Using HPLC

An aliquot from the acid hydrolyzed sample solution was further filtered using 0.22 μm syringe filters into 2 mL vials (Agilent, USA) for sugar analysis. Sugars were analyzed by a high-pressure liquid chromatography (HPLC) using Agilent 1200 series HPLC System (Agilent, USA) equipped with a refractive index detector. The monosaccharide content of both the original liquor as well as the acid hydrolyzed liquor was determined by HPLC equipped with Bio-Rad HPX 87 P (300×7.8 mm) column at 80° C. and a guard column (Bio-Rad Laboratories, USA) by injecting 20 μL of the sample solution and eluting the column with HPLC grade water (Sigma Aldrich, USA). The standard sugars used for identification and quantification were glucose, xylose, arabinose, galactose, and mannose (Sigma Aldrich, USA). The retention times of glucose, xylose, and arabinose were 13.159, 14.520 and 17.445 min, respectively.

The XOS in the original liquor were analyzed by HPLC equipped with Bio-Rad HPX 42 A column at 80° C. and a guard column (Bio-Rad Laboratories, USA) by eluting the column with a HPLC grade water (Sigma Aldrich, USA) at a flow-rate of 0.6 mL/min. The XOS standards used were xylobiose, xylotriose, xylotetrose, xylopentose, and xylohexose along with a monomer xylose (Megazymes, Ireland). The retention time for xylotriose was 14.948 min and for xylohexose was 11.012 min, respectively. The acidic components present in the original liquor were analyzed by HPLC equipped with Bio-Rad HPX 87 H (300×7.8 mm) column at 80° C. and a guard column (Bio-Rad Laboratories, USA) by eluting with 0.005M H₂SO₄ at a flow rate of 0.6 mL/min. Standard acids used were acetic acid, formic acid, levulinic acid, hydroxymethyl furfural (HMF), and furfural (Sigma Aldrich, USA). The retention time noted for acetic acid was 13.655 min.

### 3. Results and Discussion

The sugar composition of the corn fiber was glucan 18.0%, xylan 16.8%, arabinan 8.8%, mannan 0.8%, galactan 3.0%, and lignin content 1.3%, on wet basis. Thus, the cellulose content represented 18.0% and hemicelluloses content, comprising xylan, arabinan, galactan and mannan chains, represented 29.4. % in the corn fiber. Based on the composition of corn fiber, the maximum expected amounts of glucose, xylose, arabinose, galactose, and mannose monosugars were 2.0 g, 1.9 g, 1.0 g, 0.3 g, and 0.0 g, respectively. Thus the total expected maximum amount of monosugars based on its composition was around 5.2 g.

The liquor, or hydrolysate, obtained after autohydrolysis of fiber in the Parr-reactor at temperatures ranging from about 140-220° C. consisted mostly of a oligomers mixture of xylose with some free arabinose and glucose (Table 1). When the temperature was raised above about 200° C., the formation of some toxic compounds were seen. As reported by Aoyama, (1996), Garrote, et al. (1999), and Carvalheiro, et al. (2004), production of XOS depended upon temperature. As temperature increased from about 180° C. to 220° C., the XOS production decreased but the decomposition/toxic compounds such as HMF, furfural, and acetic acid increased as reported by Carvalheiro, et al. (2004). The maximum amount of XOS from the original liquor was obtained at temperatures of about 170-180° C. (Table 1). The amount of XOS in the original liquor increased with increasing temperature up to about 180° C., but decreased on further increase of temperature. The xylose content in the acid hydrolyzed liquor expected based on hydrolysis of measured XOS was higher than measured xylose content until a temperature of about 150° C. This is perhaps because of co-eluting of other sugar-oligosaccharides with XOS in the Aminex 42-A column, which was also observed when analyzing standard samples; cellobiose co-eluted with xylotriose. As temperature increased, there was an increase in the breakdown products of other sugar-polymers (cellulan, arabinan, and galactan) into monomers showing higher levels of monomers (arabinose, galactose, and glucose) at higher temperatures up to about 180° C. (Table 2). This degradation of carbohydrate polymers into monomers resulted in a decrease of other-sugar oligosaccharides, which probably led to lesser co-elution of XOS at higher temperature and thus, the xylose content in acid hydrolyzed liquor was higher than the minimum xylose content expected from hydrolysis of measured XOS. Thus, the measured XOS values at higher temperatures are expected to be closer to actual values at temperatures higher than about 160° C.

The breakdown of xylan polymer increased on the increase of temperature. There was an increase in the xylose content from 316 mg to 2064 mg in the original liquor as temperature increased from about 140° C. to about 180° C. (Table 1). The maximum production of XOS was at about 180° C., containing mainly xylotriose (1645 mg) and xylopentose (221 mg). The XOS produced at about 170° C. consisted mainly of a mixture of xylotriose (1483 mg), xylotetrose (142 mg), xylopentose (146 mg), and xylohexose (20 mg). At about 170° C., the original liquor showed the presence of a mixture of xylotriose, xylotetrose, and xylopentose when autohydrolysis was conducted at about 170° C. But, when the autohydrolysis was done at about 180° C., it showed a mixture of only xylotriose and xylopentose, which may be due to co-elution of xylotetrose and xylohexose with xylotriose/xylopentose. It is evident from data presented in Table 1 that hemicellulose certainly hydrolyzed on heating to form xylo-oligosaccharides. The production of total XOS at about 170° C. and about 180° C. of 1790 and 1865 mg, respectively, (Table 1) were comparatively higher than their yield at other temperatures used.

The breakdown of arabinan into monomer seems to be complete at about 170° C. as indicated by the highest arabinose content (1647 mg) in the original liquor at this temperature. At higher temperatures, the arabinose content in original liquor decreased because of its conversion into other compounds (Table 2). The breakdown of galactan and cellulose to their respective monomers are complete at about 180° C. as indicated by the highest galactose and glucose contents (700 and 1424 mg, respectively) in original liquor at about 180° C. The HPLC analysis results of XOS and monosaccharides at 170/180° C. (temperatures at which non-xylan sugars break down completely into monomers) were comparable to the expected composition of the original fiber. The validity of HPLC analysis results was verified by comparing the total monosugars content in the original liquor with the maximum expected monosugars content based on the carbohydrate content of the corn fiber. Total monosugars content in original liquor at 140, 150, 160, 170, and 180° C. were, 1.5, 2.4, 3.3, 4.4, and 5.0 g, respectively, which were less than the maximum expected monosugars content. Thus the HPLC analysis results were in agreement with the original corn fiber composition.

The research performed by Nunes and Pourquie (1996) were in agreement with our data regarding the formation of monosugars and OS with autohydrolysis and acid hydrolysis reactions of corn fiber in the Parr-reactor, except hydrolysis performed under acidic conditions resulted in a considerably higher concentration of monomeric sugars than the corresponding OS. The total hemicellulosic monomers content (xylose, arabinose, and galactose), inclusive of amounts if XOS is hydrolyzed, in the original liquor at about 170/180° C. was 5293 to 6347 mg.

The original liquor had no traces of formic acid and levulinic acid, which are formed on the degradation of HMF and furfural compounds (Dunlop, et al. (1940); Ulbricht, et al. (1984)). As temperature increased, the acetic acid content in the original liquor also increased due to increased production of monomers and the conversion of monomers into toxic acids (Table 1). Acetic acid production increased from 47 mg to 1723 mg as the temperature increased from about 140° C. to about 220° C. and the formation of HMF and furfural started at about 200° C. As HMF and furfural are toxic compounds, it is good that HMF and furfural were not present at 170° C. and 180° C., where the XOS production was highest. The absence of toxic compounds like acetic acid, HMF, and furfural, (the sugar degradation products of sugars) at the conditions developed by the present invention is a great advantage of the autohydrolysis process for oligosaccharides production compared to other reported technologies, such as acid hydrolysis, alkaline hydrolysis, and acid-base hydrolysis. The autohydrolysis process has an additional competitive advantage over other hydrolysis methods of no need of any chemicals to conduct this novel method and process to produce functional and health beneficial oligosaccharides.

### 4. Conclusions

The present invention shows that XOS can be produced by autohydrolysis of fiber separated from DDGS. The production of XOS increased as the temperature increased from about 140° C. to about 180° C. and XOS production was lower at temperatures of about 200-220° C. The maximum total XOS yield was 1790/1865 mg, which was obtained at about 170/180° C. Original liquor had no traces of formic acid and levulinic acid. As temperature increased, the acetic acid content in the original liquor increased due to increased production of monomers and the conversion of monomers into acids. Formation of HMF and furfural started at about 200° C. As HMF and furfural are toxic compounds, it is beneficial that HMF and furfural were not present at 170 and 180° C., where the XOS production was highest. It was also observed that, for the present invention, arabinans, galactans, and cellulose broke down into respective monosaccharides at about 170-180° C.

This disclosure has for the first time described and fully characterized a method for producing functional food ingredients such as XOS from grain products including corn fiber separated from DDGS.

TABLE 1
XOS and organic acids contents (mg) of original liquor.

| | XOS | | | | | | Acids | | |
|---|---|---|---|---|---|---|---|---|---|
| Temp | | | | | | XOS | Acetic | | |
| (° C.) | Xylose | Xylotriose | Xylotetrose | Xylopentose | Xylohexose | Total | Acid | HMF | Furfural |
| 140 | 316 | 1154 | 87 | 72 | 0 | 1314 | 47 | 0 | 0 |
| 150 | 444 | 1365 | 105 | 55 | 0 | 1524 | 50 | 0 | 0 |
| 160 | 900 | 1215 | 104 | 97 | 0 | 1415 | 72 | 0 | 0 |
| 170 | 1249 | 1483 | 142 | 146 | 20 | 1790 | 534 | 0 | 0 |
| 180 | 2064 | 1645 | 0 | 221 | 0 | 1865 | 640 | 0 | 0 |
| 200* | 574 | 535 | 0 | 0 | 0 | 535 | 1355 | 524 | 1632 |
| 220* | 0 | 190 | 0 | 0 | 0 | 190 | 1723 | 839 | 1705 |

Results are means of three replicates;
HMF—Hydroxymethylfurfural
*Results are means of only one replicate

TABLE 2
Monosaccharide content (mg) of acid hydrolyzed liquor and original liquor.

| | Minimum Xyl | | | | | | | | |
|---|---|---|---|---|---|---|---|---|---|
| | Expected in Acid | | | | | | | | |
| | Hydrolyzed | | | | | | | | |
| | Liquor Based on | Monosaccharides | | | | | | | |
| | XOS values from | measured in | | | | Monosaccharides measured | | | |
| | oligosaccharide | acid hydrolyzed liquor | | | | in original liquor | | | |
| Temp (° C.) | column | Xyl | Glu | Gal | Ara | Xyl | Glu | Gal | Ara |
| 140 | 1746 | 438 | 1446 | 299 | 433 | 366 | 656 | 0 | 435 |
| 150 | 2104 | 930 | 1477 | 238 | 647 | 436 | 661 | 115 | 1002 |
| 160 | 2442 | 2729 | 1525 | 456 | 1018 | 636 | 1023 | 213 | 1398 |
| 170 | 3199 | 3778 | 1269 | 0 | 1152 | 1011 | 1275 | 447 | 1647 |
| 180 | 4096 | 5096 | 1291 | 0 | 1066 | 1312 | 1424 | 700 | 1578 |
| 200* | 1156 | 1385 | 1262 | 0 | 0 | 1072 | 1294 | 639 | 875 |
| 220* | 206 | 479 | 403 | 0 | 99 | 0 | 405 | 0 | 0 |

Results are means of three replicates.
*Results are means of only one replicate.
Xyl—Xylose,
Glu—Glucose,
Gal—Galactose,
Ara—Arabinose

### REFERENCES

Aoyama, M., 1996. Steaming treatment of bamboo grass. II. Characterization of solubilized hemicellulose and enzymatic digestibility of water-extracted residue. Cell. Chem. Technol. 30, 385-393.
Carvalheiro, F., Esteves, M. P., Parajó), J. C., Pereira, H., Gírio, F. M., 2004. Production of oligosaccharides by autohydrolysis of brewery's spent grain. Bioresource Technol. 91, 93-100.
Chu, V. C., Whittaker, G. R., 2004. Influenza virus entry and infection require host cell N-linked glycoprotein. Proc. Natl. Acad. Sci. USA. 101, 18153-18158.
Dunlop, A. P., 1948. Furfural formation and behaviour. Ind. Eng. Chem. 40, 204-209.
Faissner, A., Clement, A., Lochter, A., Streit, A., Mandl, C., Schachner, M., 1994. Isolation of a neural chondroitin sulfate proteoglycan with neurite outgrowth promoting properties. J. Cell Biol. 126, 783-799.
Garcia, R., Toshiyuki, N., Praxedes, A., Raffin, F., Moura, T., Egito, S., 2001. Preparation of micro and nanoparticles from the carbon cobs xylan. Polym. Bull. 46, 371-379.
Garrote, G., Dominguez, H., Parajo, J. C., 1999. Mild autohydrolysis: an environmental friendly technology for xylo-oligosaccharides production from wood. J. Chem. Technol. Biotechnol. 74, 1101-1109.
Gibson, G., 2001. Fibre and effects on probiotics (the prebiotic concept). Clin. Nutr. Supplements. 1, 25-31.
Gibson, G. R., Roberfroid, M. B., 1995. Dietary modulation of the human colonic microbiota: introducing the concept of prebiotics. J. Nutr. 125, 1401-1412.
Hakomori, S., Kannagi, R., 1983. Glycosphingolipids as tumor associated and differentiation makers. J. National Cancer Institute. 71, 231-251.
Kawakubo, M., Ito, Y., Okimura, Y., Kobayashi, M., Sakura, K., Kasama, S., Fukuda, M. N., Fukuda, M., Katsuyama, T., Nakayama, J., 2004. Naturalantibiotic function of a human gastric mucin against Helicobacter pylori infection. Science. 305, 1003-1006.
Lindblad, S. M., Ranucci, E., Albertsson, A., 2001. Biodegradable polymers from renewable sources. New hemicellulose—based hydrogels. Macromol. Rapid Comm. 22, 962-967.
Nakakuki, T., 1993. Oligosaccharides: Production, Properties and Applications, Japanese Technology Reviews. Vol. 3, No. 2, Gordon and Breach, Switzerland.
Nunes, A. P., Pourquie, J., 1996. Steam explosion pretreatment and enzymatic hydrolysis of eucalyptus wood. Bioresource. Technol. 57, 107-110.
Ohtsubo, K., Marth, J. D., 2006. Glycosylation in cellular mechanisms of health and disease. Cell. 126, 855-867.
Rivas, B., Dominguez, J., Domínguez, H., Parajó, J., 2002. Bioconversion of posthydrolysed autohydrolysis liquors: an alternative for xylitol production from corn cobs. Enzyme Microb. Tech. 31, 431-438.
Srinivasan, R., Singh, V., Belyea, R. L., Rausch, K. D., Moreau, R. A., Tumbleson, M. E., 2006. Economics of fiber separation from Distillers Dried Grain with Solubles (DDGS) using Sieving and Elutriation. Cereal Chem. 83, 324-330.
Srinivasan, R., To, F., Columbus, E., 2009. Pilot scale fiber separation from distillers dried grains with solubles (DDGS) using sieving and air classification. Bioresource Technol. 100, 3548-3555.
Ulbricht, R. J., Sharon, J., Thomas, J., 1984. A review of 5-hydroxymethylfurfural (HMF) in parental solutions. Fundam. Appl. Toxicol. 4, 843-853.

The above detailed description is presented to enable any person skilled in the art to make and use the invention. Specific details have been revealed to provide a comprehensive understanding of the present invention, and are used for explanation of the information provided. These specific details, however, are not required to practice the invention, as is apparent to one skilled in the art. Descriptions of specific applications, analyses, and calculations are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown and the invention is to be accorded the widest possible scope consistent with the principles and features disclosed herein.

While various embodiments of the present invention have been described above, it should be understood that they have been presented by way of example and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. The processes, methods, and system of the present invention are often best practiced by empirically determining the appropriate values of the operating parameters, or by conducting simulations to arrive at best design for a given application. Accordingly, all suitable modifications, combinations, and equivalents should be considered as falling within the spirit and scope of the invention.

What is claimed is:

1. A method for producing functional food ingredients from at least one grain product, the method comprising:
treating the at least one grain product with deionized water in a reactor by autohydrolysis to form a hydrolysate, wherein the temperature in the reactor is held constant for an effective amount of time at a temperature of from about 140° C. to about 200° C.;
filtering at least once the hydrolysate by gravity, by vacuum filtration, or by a combination thereof, to remove residue and to remove at least one toxic compound; and
washing the hydrolysate with deionized water and drying the hydrolysate at room temperature.

2. The method of claim 1, wherein the functional food ingredients are oligosaccharides.

3. The method of claim 2, wherein the oligosaccharides are xylo-oligosaccharides (XOS).

4. The method of claim 1, wherein the at least one grain product is corn fiber.

5. The method of claim 4, wherein the corn fiber is corn fiber separated from corn.

6. The method of claim 5, wherein the corn fiber is corn fiber separated from distillers dried grains with solubles (DDGS).

7. The method of claim 1, wherein the effective amount of time that the temperature in the reactor is held constant is about 15 minutes.

8. The method of claim 1, wherein the temperature in the reactor is from about 170° C. to about 180° C.

9. The method of claim 8, wherein the hydrolysate produced at a temperature of from about 170° C. to about 180° C. comprises no toxic compounds.

10. The method of claim 1, wherein the at least one toxic compound removed by filtering is formic acid, levulinic acid, or a combination thereof.

11. A method for producing functional food ingredients from at least one grain product, the method comprising:
treating the at least one grain product with deionized water in a reactor by autohydrolysis to form a hydrolysate, wherein the at least one grain product is produced by elusive fractionation and wherein the temperature in the reactor is held constant for an effective amount of time at a temperature of from about 140° C. to about 200° C.;
filtering at least once the hydrolysate by gravity, by vacuum filtration, or by a combination thereof, to remove residue and to remove at least one toxic compound; and
washing the hydrolysate with deionized water and drying the hydrolysate at room temperature.

12. The method of claim 11, wherein the functional food ingredients are oligosaccharides.

13. The method of claim 12, wherein the oligosaccharides are xylo-oligosaccharides (XOS).

14. The method of claim 11, wherein the at least one grain product is corn fiber.

15. The method of claim 14, wherein the corn fiber is corn fiber separated from corn.

16. The method of claim 15, wherein the at least one grain product is fiber or hulls, or a combination thereof, separated from distillers dried grains with solubles (DDGS), ground corn flour, ground barley flour, ground wheat flour, ground sorghum flour, soybean meal, or a combination thereof.

17. The method of claim 11, wherein the effective amount of time that the temperature in the reactor is held constant is about 15 minutes.

18. The method of claim 11, wherein the temperature in the reactor is from about 170° C. to about 180° C.

19. The method of claim 18, wherein the hydrolysate produced at a temperature of from about 170° C. to about 180° C. comprises no toxic compounds.

20. The method of claim 11, wherein the at least one toxic compound removed by filtering is formic acid, levulinic acid, or a combination thereof.
